(19) United States
(12) Patent Application Publication
(10) Pub. No.: US 2007/0098085 A1
(43) Pub. Date: May 3, 2007

(54) Audio/video signal processor with storage function

(75) Inventor: Yu-Chiang Shih, Taipei Hsien (TW)

Correspondence Address: BIRCH STEWART KOLASCH & BIRCH, PO BOX 747, FALLS CHURCH, VA, 22040-0747, US

(73) Assignee: ANIMATION TECHNOLOGIES INC.

(21) Appl. No.: 11/543,122

(22) Filed: Oct. 5, 2006

(30) Foreign Application Priority Data
Oct. 27, 2005 (TW) 094218594

(51) Int. Cl. H04N 7/12

(52) U.S. Cl. 375/240.26

(57) ABSTRACT

An audio/video signal processor with storage function is disclosed. According to an aspect of the present invention, a signal receiver is provided to receive and transmit a external TV signal to a signal processor for demodulation thereof. Next, an encoder/decoder is adopted for encoding/decoding the demodulated TV signal and then transmitting the encoded/decoded TV signal to a host end for playing and as well as storing the TV signal in a memory. Thus, a user can simultaneously view and record the TV programs anytime and without missing any parts of the favorite TV program.

### BACKGROUND OF THE INVENTION

1. Field of the Invention

The present invention generally relates to an audio/video signal processor with storage function, and more particularly to an audio/video signal processor capable of storing TV signal for enabling a user to view and record the TV program simultaneously, and the user may also view and record the TV programs in a different host end at anytime and from anywhere.

2. Description of the Related Art

The development of the TV set is from initially black-n-white CRT TV, color CRT TV to the present digital TV and plasma TV. Nowadays, the display quality of the TV is better with better resolution, contrast and colors. The number of the TV channels has increased from a few to more than a hundred, and the TV signal transmission is also being upgraded to digital TV signal.

The present TV signal displaying methods, regardless of analog or digital, are in particular play mode, for example the display being connected to a signal receiver/transmitter using a signal cable for receiving the video and audio signal to play on the display. The computer display has to be connected to the computer to display the information stored in the computer. However, the computer display has different purpose along with the new development, in that, the user can have an on-time and online video signal connection via the web camera when the computer connects to the far end signal through the internet. Accordingly, the computer display has more purposes than before. When the computer display can play the far end video signal, the computer display can be used as a TV display. However, the design of the computer display is different from that of the TV display, and also the programs for receiving and transmission, and execution of the audio and video signals are different as well. Therefore, the user has to connect a TV box or the TV card to convert the TV audio/video signals into the signals suitable for the computer in order to view the TV programs on the computer display.

Generally speaking, users work or study in the daytime, and also the user may have to work or study in the nighttime, and it may not be possible to stay tuned to the TV the whole day for watching the favorite programs. At times when the favorite TV programs are played while the user is busy dealing with other work, the user has to record the programs using a recorder. The conventional recorder includes, for example, tape recorder and tape, are inconvenient to carry and occupying a lot of space. Besides, the tape recorder must be stored at places where the humidity is low and free from the magnetic field. The user may also use the computer to record TV programs in the hard disk if the computer display is used to display the TV programs, however, the computer hard disk occupies the computer source, and the recorded file has to be compressed into the smaller file.

Therefore, how to overcome defect of the conventional art is an important issue for the manufacturers in the field.

### SUMMARY OF THE INVENTION

According to an aspect of the present invention, a signal receiver is provided to receive and transmit a external TV signal to a signal processor for demodulation thereof. Next, an encoder/decoder is adopted for encoding/decoding the demodulated TV signal and then transmitting the encoded/decoded TV signal to a host end for playing as well as storing the TV signal in a memory. Thus, the user can simultaneously view and record the TV programs anytime and without missing any parts of the favorite TV program.

According to another aspect of the present invention, a connection portion may be connected to an external storage device to enable the user to switch to the external storage device for recording. Thus, when the memory capacity of the external storage device is insufficient, the user only has to change to another external storage device to continue recording without deleting the recording in the external storage device.

### BRIEF DESCRIPTION OF THE DRAWING

FIG. 1 is a block diagram of audio/video processor according to an embodiment of the present invention.

FIG. 2 is an operation procedure of the audio/video processor according to a first embodiment of the present invention.

FIG. 3 is an operation procedure of the audio/video processor according to a second embodiment of the present invention.

FIG. 4 is a block diagram of a audio/video processor according to another embodiment of the present invention.

### DETAIL DESCRIPTION OF THE INVENTION

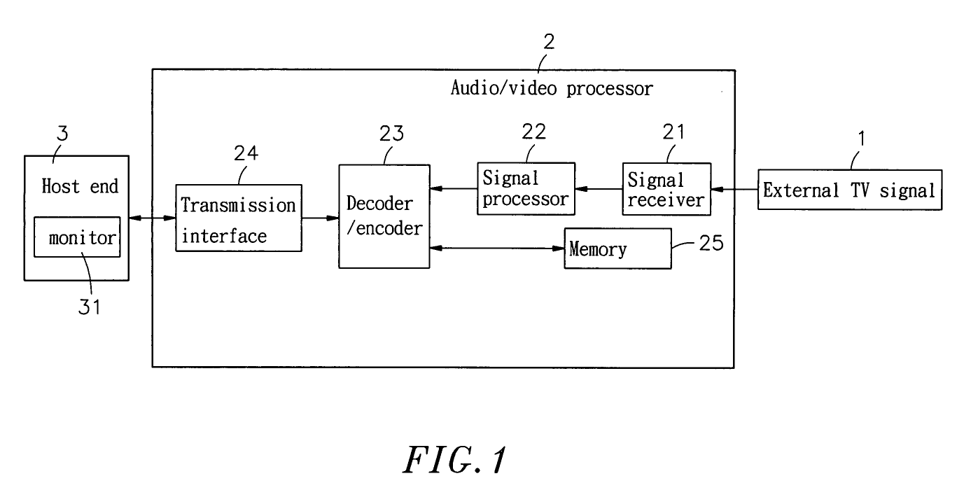

Referring to FIG. 1, an audio/video processor 2 of the present invention comprises a signal receiver 21, a signal processor 22, a decoder/encoder 23, a transmission interface 24 and a memory 25.

The signal receiver 21 is adopted for receiving an external TV signal 1, and can be comprised of a radio frequency receiver or a coaxial cable connector.

The signal processor 22 is electrically connected to the signal receiver 21, and the signal processor 22 is adopted to demodulate the TV signal 1 transmitted by the signal receiver 21 to separate the TV signal 1 from a carrier. The signal processor 22 can be a single chip processor or a multi-chip processor.

The decoder/encoder 23 is electrically connected to the signal processor 22 and is adopted to decode/encode the demodulated TV signal 1 to restore the TV signal 1 into a playable digital signal.

The transmission interface 24 is adopted to transmit the decoded/encoded TV signal 1 from the decoder/encoder 23 to a host end 3 for playing.

The memory 25 is adopted to store the decoded/encoded TV signal 1 from the decoder/encoder 23, and may be comprised of a non-volatile memory, a flash memory or a hard disk.

The above transmission interface 24 can be a peripheral component interconnect (PCI), a MINI-PCI, a MINI-CARD, a personal computer memory card international association (PCMCIA), a peripheral component interconnect express (PCI-Express), a express card USB or any other transmission interface with equivalent function. The above-examples are used for only illustrating the embodiment of the transmission interface 24 and not for limiting the scope of the present invention, and it should be understood that any variation of the above-examples are still construed to be within the scope of the present invention.

Furthermore, the TV signal 1 can be a digital video broadcasting terrestrial (DVB-T), a digital video broadcasting cable (DVB-C), a digital video broadcasting handheld (DVB-H), a digital video broadcasting satellite (DVB-S), an advanced television systems committee (ATSC), an integrated services digital broadcasting terrestrial (ISDB-T), a digital multimedia broadcasting (DMB-T) or an analogue TV signal. The above-examples are used for illustrating the embodiment of the TV signal 1, and it should be understood that any variation of the above-examples are still construed to be with the scope of the present invention.

To operate the audio/video signal processor 2 of the present invention, first, the signal receiver 21 is adopted to receive the external TV signal 1. Because the TV signal 1 is transmitted by the carrier, and therefore, the TV signal 1 is transmitted to the signal processor 22 from the signal receiver 21 to separate the TV signal 1 from the carrier. Next, after the TV signal 1 is being separated from the carrier, it is converted by the decoder/encoder 23 into a digital multimedia-playing format or a digital multimedia streaming image format, and then the converted TV signal 1 is transmitted to the memory 25 for storage. When a user wishes to view the TV signal 1 stored in the memory 25, the decoder/encoder 23 retrieves the TV signal 1 from the memory 25 and transmits the TV signal 1 via the transmission interface 24 to the host end 3 for playing on a monitor 31.

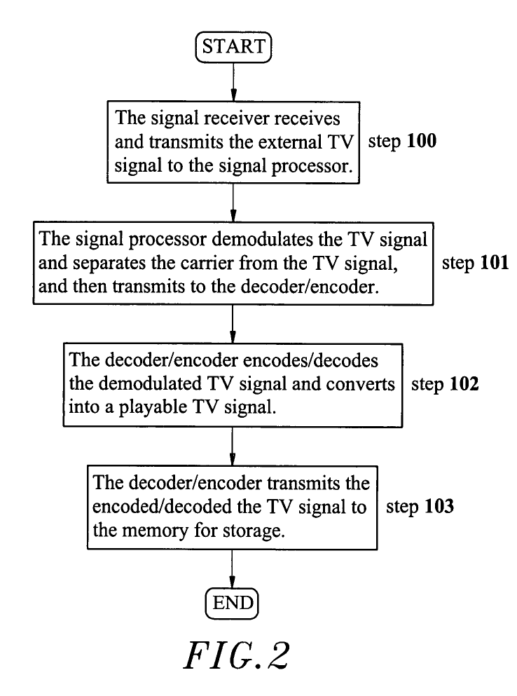

Hereinafter, the procedure of storing the TV signal 1 in the memory 25 according the first embodiment of the present invention will be described with referring to FIG. 1 and 2.

At step 100, the signal receiver 21 receives and transmits the external TV signal 1 to the signal processor 22.

At step 101, the signal processor 22 demodulates the TV signal 1 and separates the carrier from the TV signal 1, and then transmits the demodulated TV signal 1 to the decoder/encoder 23.

At step 102, the decoder/encoder 23 encodes/decodes the demodulated TV signal 1 and converts into a playable TV signal 1.

At step 103, the decoder/encoder 23 transmits the encoded/decoded TV signal 1 to the memory 25 for storage.

Thus, to proceed the video processing, first, the signal receiver 21 is used to receive the external TV signal 1. Because the TV signal 1 is transmitted by the carrier, and therefore, the TV signal 1 is transmitted to the signal processor 22 from the signal receiver 21 to separate the TV signal 1 from the carrier. The TV signal 1 separated from the carrier is then converted by the decoder/encoder 23 into a digital multimedia-playing format or a digital multimedia streaming image format and then transmitted via the transmission interface 24 to the host end 3 for playing on the monitor 31. Meanwhile, the host end 3 can proceed the image processing to the TV signal 1, for example, the image synthesis, the image modification, the filtering, the purifying, the sharpening, the editing, the audio processing and so on, and then the processed TV signal 1 is transmitted back to the decoder/encoder 23 via the transmission interface 24 to the memory 25 for storage. The storage format of the memory 25 is a digital multimedia-playing format or a digital multimedia streaming image format, for example, MPEG layer 2 (MP2), MPEG layer 3 (MP3), MPEG player 4 (MP4), real media variable bitrate (RMVB), real media (RM), advanced streaming format (ASF), windows media audio (WMA) and audio/video interleaved (AVI). The above-examples are only used for illustrating the embodiment of storing the TV signal 1 into the memory 25 by the decoder/encoder 23, and it is not intended to limit the scope of the present invention, and it should be noted that any equivalent may be used to achieve the purpose of present invention shall be construed to be within the scope of the present invention.

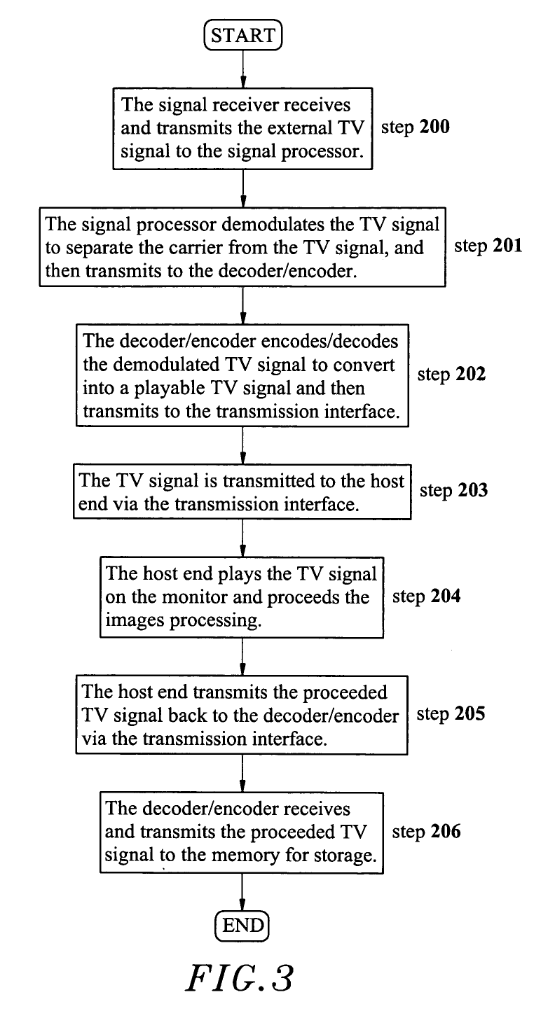

Hereinafter, the procedure of storing the TV signal 1 in the memory 25 according to the second embodiment of the present invention will be described with referring to FIG. 1 and 3.

At step 200, the signal receiver 21 receives and transmits the external TV signal 1 to the signal processor 22.

At step 201, the signal processor 22 demodulates the TV signal 1 to separate the carrier from the TV signal 1, and then transmits the demodulated TV signal 1 to the decoder/encoder 23.

At step 202, the decoder/encoder 23 encodes/decodes the TV signal 1 to convert the TV signal 1 into a playable TV signal 1 and then transmits to the transmission interface 24.

At step 203, the TV signal 1 is transmitted to the host end 3 via the transmission interface 24.

At step 204, the host end 3 plays the TV signal 1 on the monitor 31 and proceeds the images processing.

At step 205, the host end 3 transmits the proceeded TV signal 1 back to the decoder/encoder 23 via the transmission interface 24.

At step 206, the decoder/encoder 23 receives and transmits the proceeded TV signal 1 to the memory 25 for storage.

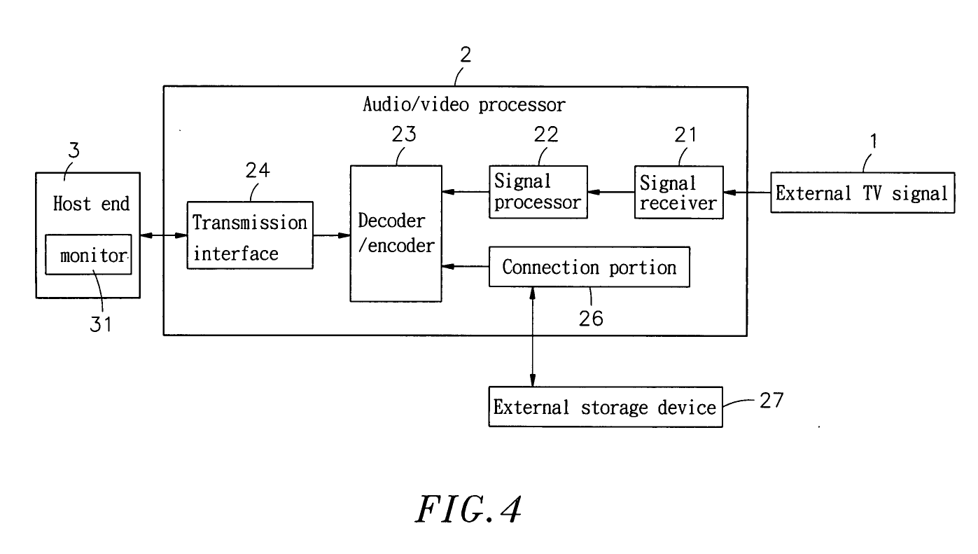

Referring to FIG. 4, the decoder/encoder 23 is electrically connected to a connection portion 26, and the connection portion 26 is connected to an external storage device 27. The TV signal 1 received by the signal receiver 21 is demodulated and encoded/decoded by the signal processor 22 the decoder/encoder 23, and then stored into the external storage device 27 via the connection portion 26. Thus, the user can carry the external device 27 storing the TV signal 1 and share with other users. The connection portion 26 can be a receiving portion or a slot with specification such as the institute of electrical and electronic engineers standard bus interface 1394 (IEEE1394), the recommended standard-232 (RS-232), the universal serial bus (USB), the serial advanced technology attachment (SATA) or the small computer standard interface (SCSI). The external storage device 27 can be a portable stick with specification such as the institute of electrical and electronic engineers standard bus interface 1394 (IEEE1394), the recommended standard-232 (RS-232), the universal serial bus (USB), the serial advanced technology attachment (SATA) or the small computer standard interface (SCSI), or the compact flash memory card (CF card), the memory stick memory card (MS card), the multi media memory card (MC card), the smart media memory card (SM card) or the secure digital memory card (SD card).

The signal processor 22 can be a signal chip processor or a multi-chip processor. Alternatively, the signal processor 22 can be a digital signal processor, an analogue signal processor or a signal processor with demodulation function. The above examples are for purpose of only illustrating the embodiment of signal processor 22 and are not intended for limiting the scope of the present invention. It should be understood that any signal processor with equivalent function shall be construed to be within the scope of the present invention.

Accordingly, the present invention has at least the following advantages.

1. The present invention allows the TV signal 1 to be stored in the memory 25 so that the user may be able to carry and/or view anywhere/anytime.

2. The user may carry the audio/video processor 2 and connect to a TV or a computer to view the TV signal 1 stored in the memory 25, and the stored TV signal 1 may also be shared with other users.

3. The audio/video processor 2 can be connect to a host end 3 through the transmission interface 24 to proceed the image processing for providing better effect according to the user's requirement. Besides, the proceed TV signal 1 can be transmitted back to the memory 25 for storage so that the user may be able to view anytime and at any places, or share the stored TV signal 1 with other users.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What the invention claimed is:

1. An audio/video processor with storage function, comprising:
a signal receiver, for receiving and transmitting an external TV signal;
a signal processor, electrically connected to said signal receiver, for receiving, demodulating and transmitting said external TV signal transmitted from said signal receiver;
a decoder/encoder, electrically connected to said signal processor, for receiving, decoding/encoding and transmitting said demodulated TV signal transmitted from said signal processor;
a transmission interface, electrically connected to said decoder/encoder, for receiving and transmitting said decoded/encoded TV signal transmitted from said decoder/encoder to a host end for playing; and
a memory, electrically connected to said decoder/encoder, for storing said decoded/encoded TV signal.

2. An audio/video processor with storage function, comprising:
a signal receiver, for receiving an external TV signal;
a signal processor, electrically connected to said signal receiver, for receiving, demodulating and transmitting said external TV signal transmitted from said signal receiver;
a decoder/encoder, electrically connected to said signal processor, for receiving, decoding/encoding and transmitting said demodulated TV signal transmitted from said signal processor;
a transmission interface, electrically connected to said decoder/encoder, for receiving and transmitting said decoded/encoded TV signal transmitted from said decoder/encoder to a host end for playing; and
a connection portion, electrically connected to said decoder/encoder, for connecting to an external storage device for storing said decoded/encoded TV signal.

3. The audio/video processor with storage function according to claim 1 or 2, wherein said TV signal comprises a digital TV signal of DVB-T, DVB-C, DVB-H, DVB-S, ASTSC, ISDB-T, DMB-T or an analogue TV signal.

4. The audio/video processor with storage function according to claim 1 or 2, wherein said signal receiver comprises a radio frequency receiver or a coaxial cable connector.

5. The audio/video processor with storage function according to claim 1 or 2, wherein said signal processor comprises a digital signal processor, an analogue signal processor or a signal processor with demodulation function.

6. The audio/video processor with storage function according to claim 1 or 2, wherein said signal processor comprises a signal chip processor or a multi-chip processor.

7. The audio/video processor with storage function according to claim 1 or 2, wherein said transmission interface comprises PCI, MINI-PCI, MINI-CARD, PCMCIA, PCI-EXPRESS, EXPRESS CARD or USB.

8. The audio/video processor with storage function according to claim 1, wherein said memory comprises a non-volatile memory, a flash memory or a hard disk.

9. The audio/video processor with storage function according to claim 2, wherein said connection portion is connected to said external storage device with a specification including USB, SATA or IDE, or a memory card.

10. The audio/video processor with storage function according to claim 2, wherein said external storage device comprises a portable stick, a CF card, a MS card, a MMC card, a SM card or a SD card.
